(19) United States
(12) Patent Application Publication
(10) Pub. No.: US 2007/0040987 A1
(43) Pub. Date: Feb. 22, 2007

(54) Method for manufacturing spectacles frames

(76) Inventor: C.S. Liang, Changhua City (TW)

Correspondence Address: BRUCE H. TROXELL;SUITE 1404, 5205 LEESBURG PIKE, FALLS CHURCH, VA, 22041, US

(21) Appl. No.: 11/205,106

(22) Filed: Aug. 17, 2005

(51) Int. Cl. G02C 5/00

(52) U.S. Cl. 351/41

(57) ABSTRACT

A method for manufacturing spectacles frames includes the steps of: 1. fabricating elements of the spectacles frames; 2. performing surface treatment by boiling off; 3. performing surface treatment with a germanium alloy; and 4. assembling. The spectacles frames thus formed have physical characteristics of germanium. Hence the spectacles frames have more added value, and also can improve the health and comfort of human eyes.

### BACKGROUND OF THE INVENTION

1. Field of the Invention

The invention relates to a method for manufacturing spectacles frames to provide physical characteristics of germanium on the spectacles frames thereby to increase added value of the spectacles frames and improve health and comfort of human eyes.

2. Description of the Prior Art

There are a wide variety of spectacles on the market. The spectacles frames have evolved from the steel wire frames in the past to light weight titanium frames at present. The characteristics of titanium can improve the health and comfort of human eyes. In recent years, various new elements have been adopted. The most notable trend is using nanometer technology and germanium. Researches have proved that germanium can improve blood circulation of human body. Hence using germanium to fabricate spectacles frames is a commendable idea. The atom of germanium has four negative electrons on the orbit. At 32° C. one of the electrons will escape from the orbit. While the electron escapes, it will be replenished from the atmosphere. This characteristic creates an ionization effect, and can isolate or interfere electromagnetic wave. This effect can balance the positive and negative electrons around human eyes, and improve blood circulation around the human eyes. However, germanium is very expensive. To make the entire spectacles frames from germanium or its alloy is too costly. Moreover, the aforesaid advantage of improving blood circulation around the eyes can be achieved by using a small amount of germanium. Therefore the present invention aims to provide a method to fabricate spectacles frames that contain germanium.

The conventional method 1 for manufacturing metal spectacle frames (referring to FIG. 1) generally includes the following steps:
1. Fabricate spectacles frame elements (step 11): Form various elements of spectacles frames needed by cutting metal wires and forming through molds, including eyewires and end pieces by soldering.
2. Perform surface treatment by boiling off (step 12): Rinse the surface of the eyewires and end pieces with an acid-based solution to remove grease.
3. Perform surface treatment by plating (step 13): Treat the surface by electroplating to form a desired color, such as copper color, platinum color, K-gold color or the like.
4. Assemble (step 14): Couple the distal end of each end piece with a protective sleeve, and couple the eyewires with hinges to form finished products of the spectacles frames.

### SUMMARY OF THE INVENTION

The conventional manufacturing method 1 set forth above is a general fabrication process, and cannot add germanium on the finished product. Its added value is limited.

To overcome the drawbacks of the conventional method of manufacturing spectacles frames that does not offer much added value, the present invention aims to provide a method for manufacturing spectacles frames that allows the finished product to contain desired characteristics of germanium to enhance the added value. The method of the invention includes the following procedures: 1. fabricate elements of spectacles frames; 2. perform surface treatment by boiling off; 3. perform surface treatment with a germanium alloy; and 4. assemble.

By means of the process set forth above, the germanium can be widely applied on the spectacles frames at a minimum cost so that the spectacles frames have the physical characteristics of germanium.

The method of the invention can further include the follow steps: 1. fabricate elements of spectacles frames; 2. perform surface treatment by boiling off; 3. perform surface treatment with a germanium alloy; 4. perform surface treatment for a second time; and 5. assemble. The spectacles frames thus formed have a desired color and are more appealing.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a flow chart of a conventional method for manufacturing spectacles frames.

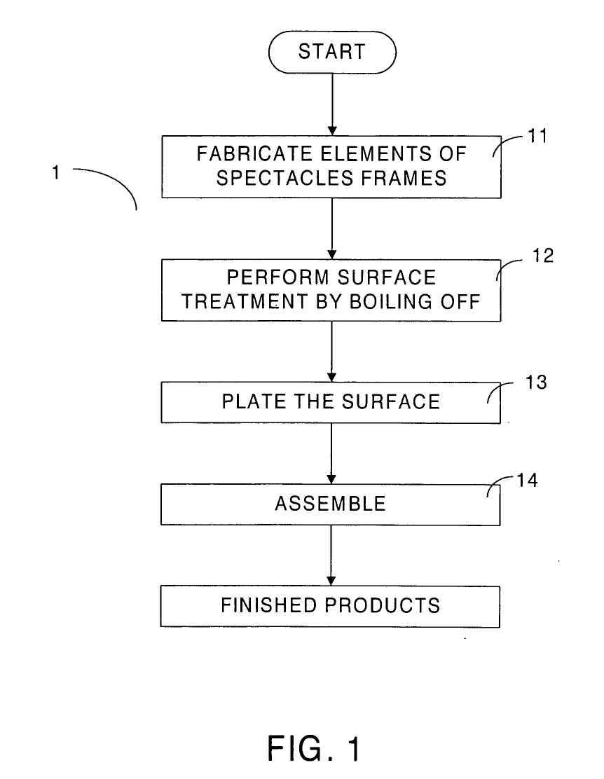

FIG. 2 is a flow chart of the method for manufacturing spectacles frames according to the invention.

FIG. 3 is a perspective view of an embodiment of a spectacles frame of the invention.

### DESCRIPTION OF THE PREFERRED EMBODIMENTS

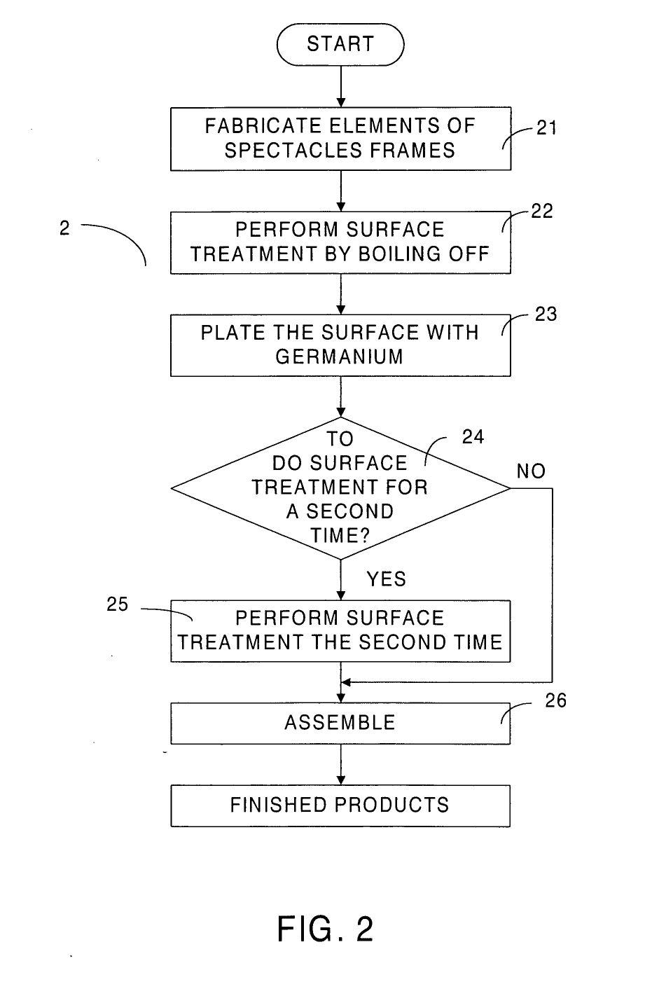

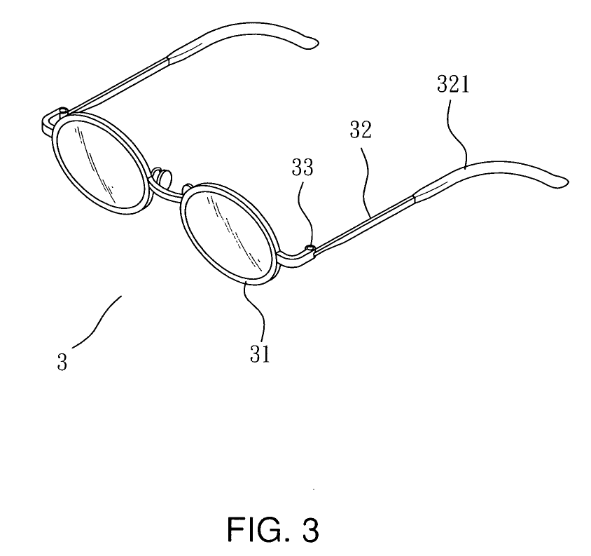

Referring to FIGS. 2 and 3, the method 2 for manufacturing spectacles frames of the invention includes the following procedures:
1. Fabricate elements of spectacles frames (step 21): Form various elements needed for a spectacles frame 3 by cutting metal wires and forming through molds, including eyewires 31 and end pieces 32 by soldering;
2. Perform surface treatment by boiling off (step 22): Rinse the surface of the eyewires 31 and end pieces 32 with an acid-based solution to remove grease;
3. Perform surface treatment with a germanium alloy (step 23): Plate the eyewires 31 and end pieces 32 with germanium so that a layer of germanium is formed on the surface of the elements; and
4. Assemble (step 26): Couple the distal end of the end pieces 32 with a protective sleeve 321, and couple the eyewires 31 with hinges 33 to form finished products of the spectacles frame 3.

The spectacles frame 3 fabricated by the procedures previously discussed is coated with the original color of germanium on the surface. It can hardly meet the multi-color trend now prevails on the market. Hence after the surface treatment with a germanium alloy at step 23, a second time surface treatment may be determined according to color requirement (step 24). If there is such a need, the second surface treatment may be performed on the surface of the germanium layer (step 25). Namely, through an electroplating process, an additional layer may be coated on the surface of the germanium layer to form a desired color, such as copper color, platinum color, K-gold color or the like to increase color diversity of the spectacles frames.

By means of the method set forth above, the spectacles frame contains germanium. The negative electrons of germanium in the germanium layer will be ionized at 32° C. The physical characteristics can balance the positive and negative electrons of human body. Thus the spectacles frame has a greater added value. And it also can improve the health and comfort of human eyes.

In short, the invention provides a surface treatment to add a layer of germanium alloy on the element surface of the spectacles frame. Hence the spectacles frame has physical characteristics of germanium that can improve the health and comfort of human eyes, and also increase the added value of the spectacles frame.

I claim:

1. A method for manufacturing spectacles frames, comprising the steps of:
A. fabricating elements of the spectacles frames: forming various elements needed for the spectacles frames by cutting metal wires and forming through molds;
B. performing surface treatment by boiling off: rinsing the surface of eyewires and end pieces with an acid-based solution to remove grease;
C. performing surface treatment with a germanium alloy: plating the eyewires and end pieces with germanium so that a layer of germanium is formed on the surface of the elements; and
D. assembling: coupling each distal end of the end pieces with a protective sleeve, and coupling the eyewires with hinges to form finished products of the spectacles frames.

2. A method for manufacturing spectacles frames, comprising the steps of:
A. fabricating elements of the spectacles frames: forming various elements needed for the spectacles frames by cutting metal wires and forming through molds;
B. performing surface treatment by boiling off: rinsing the surface of eyewires and end pieces with an acid-based solution to remove grease;
C. performing surface treatment with a germanium alloy: plating the eyewires and end pieces with germanium so that a layer of germanium is formed on the surface of the elements;
D. performing surface treatment for a second time: plating the eyewires and end pieces to form a desired surface color; and
E. assembling: coupling each distal end of the end pieces with a protective sleeve, and coupling the eyewires with hinges to form finished products of the spectacles frames.
